(19) United States
(12) Patent Application Publication
(10) Pub. No.: US 2006/0065583 A1
(43) Pub. Date: Mar. 30, 2006

(54) Separation medium and method for its preparation

(76) Inventors: David Buckley, Uppsala (SE); Philippe Busson, Uppsala (SE)

Correspondence Address: AMERSHAM BIOSCIENCES;PATENT DEPARTMENT, 800 CENTENNIAL AVENUE, PISCATAWAY, NJ, 08855, US

(21) Appl. No.: 10/536,021

(22) PCT Filed: Dec. 16, 2003
(86) PCT No.: PCT/SE03/01962

§ 371 Date: May 20, 2005

(30) Foreign Application Priority Data
Dec. 20, 2002 (GB) 0229696.0

(51) Int. Cl. B01D 15/08

(52) U.S. Cl. 210/198.2; 210/500.27; 210/502.1

(57) ABSTRACT

The present invention relates to a method of preparing a separation medium, which method comprises to provide a slurry of essentially spherical polymer beads in an aqueous solution of a natural polymer and contacting the slurry with an organic solvent in the presence of emulsifier to allow aggregation of the beads. In a preferred embodiment, the natural polymer is agarose. The present invention also encompasses a separation medium comprised of one or more aggregates, wherein each aggregate comprises a plurality of porous and essentially spherical polymer beads assembled by a porous gel.

### TECHNICAL FIELD

The present invention relates to a method of preparing a separation medium, which is useful e.g. in chromatography and filtration. Further, the invention encompasses a novel separation medium as such and use thereof to separate a compound from a liquid.

### BACKGROUND

Separation media, such as chromatography media and filtration media, are often associated with non-satisfactory properties to some end. Important factors in this field are e.g. the mass transport properties of the media, the flow properties thereof when used in chromatographic columns or as membranes, cumbersome and non-reliable methods of preparation etc. Hence, there is an ongoing development to seek improvements in this field.

Zhao and Whistler (Spherical Aggregates of Starch Granules as Flavor Carriers; Zhao, J. and Whistler, L., Food Technol. Chicago (1994), 48(7), 104-5) have discovered a property of starch granules. More specifically, small, irregularly shaped starch granules have been shown to combine into interesting and potentially useful popcorn-like structures when spray-dried with small amounts of bonding agents, such as proteins or polysaccharides. These popcorn-like structures are then useful to carry a variety of food ingredients, such as flavours, for controlled release from the porous structure of the granules. However, it is well known in this field that spray drying is not suitable in relation to more heat sensitive materials, such as agarose gels. In this context, an agarose gel would deform substantially when dried and hence result in shrunk structures of collapsed particles. Such shrunk structures are not possible to reswell to their original form.

WO 02/47665 (President and Fellows of Harvard College) relates to methods and compositions for encapsulating active agents. More specifically, assembled, selectively permeable elastic microscopic structures denoted colloidosomes are disclosed. Such colloidosomes are prepared by coating the surface of a droplet with particles and then stabilising the particles on the surface of the droplet. Thus, a colloidosome includes a shell formed of substantially spherical particles, wherein each particle is linked to neighbouring particles. The shell defines an inner chamber sized for housing an active agent.

Reeder et al (An approach to hierarchically structured porous zirconia aggregates. Reeder, David H.; Clausen, Andrew M.; Annen, Michael J.; Carr, Peter W.; Flickinger, Michael C.; McCormick, Alon V. Dep. Chem. Eng., Univ. Minnesota, Minneapolis, Minn., USA. Journal of Colloid and Interface Science (1996), 184(1), 328-330) disclose a simple, inexpensive approach to aggregate colloids into hierarchically structured spherical particles. Successive aggregation steps are used to assemble a particle that is self-similar on 2 size scales and is permeated by an ordered pore network with a bidisperse size distribution. The structure of the micro- and macropore networks as well as the mechanical integrity of the structure can be controlled by varying sintering conditions. In the finally prepared particles, there will be nothing left of the binder. One drawback of the disclosed aggregation is that the successive steps required will render the preparation thereof time-consuming and costly.

Further, U.S. Pat. No. 5,652,292 discloses suspension polymerised aqueous absorbent polymer particles, and more specifically a process for making clusters of individual polymer beads bonded together to minimise attrition in use or processing. The particles are characterised by an open structure for fast absorption of aqueous solutions and the process for making them comprises suspending a monomer mixture in a continuous phase at high shear agitation such that fine droplets of monomer are formed in an inert organic phase. A suspending agent, which prevents the clusters from coalescing, is provided. A first polyethylenically unsaturated crosslinking monomer, having substantial solubility in the aqueous phase, and an organic phase soluble initiator system are provided such that polymerisation at the surface of the polymer particles occurs to form the porous clusters of the invention. A second substantially oil soluble crosslinker is optionally provided to further crosslink the clusters such that they do not coalesce. However, since the particles are prepared by flocculation, the shape thereof will not be spherical.

Ramstorp et al (Affinity chromatographic purification of lentil lectin using immobilised yeast cells; Ramstorp, M.; Mattiasson, B.; Appl. Biochem. and Biotechn. 7, 67-70 (1982)) describe a two step inverse suspension polymerisation, wherein yeast cells are immobilised in a polyacrylamide gel. In the first step, during rapid stirring of the polymerisation mixture with toluene, CHCl₃ and a surfactant, small beads are formed. In the second step, the stirring speed is reduced to allow the beads to aggregate into raspberry-like clusters. Even though it is stated in the article that a gel with good flow properties was obtained, the figure shows a cluster comprised of as few as four beads. Aggregates of such a small size are usually too fragile for applications in packed columns, which is a preferred mode for large-scale affinity separations. In addition, from a technical point of view, it appears unlikely that the inverse suspension polymerisation process suggested by Ramstorp et al can provide spherical clusters. This is a further drawback in chromatography, since spherical materials are more packer friendly in columns.

PCT/US95/07011 (Minnesota Mining and Manufacture Company) discloses a solid phase extraction or chromatographic membrane comprised of a nonwoven fibrous matrix and hydrophobic siliceous molecular sieves enmeshed therein. More specifically, the matrix may be polytetrafluoroethylene or blown microfibres, and is defined as an open structured mass of fibres. The molecular sieves are selected from zeolites, silicates and carbon coated silicates, and molecular sieves are defined as comprising a crystal framework of aluminium and silicon atoms that form a three-dimensional network of internal cavities having honeycomb-like structures. The membrane is suggested for use in planar chromatography, and is stated to provide significant advantageous over particle packed columns.

U.S. Pat. No. 5,476,665 discloses a composite membrane, which is comprised of covalently azlactone functional particles incorporated in a membrane formed by solvent phase inversion. The azlactone functional particles of the composite membrane will determine biological or chemical interaction with analytes in a fluid, while the function of the continuous, porous matrix will be to enable physical interaction with such analytes in the fluid. The inventors of U.S. Pat. No. 5,476,665 found that the composite membrane could be formed by solvent phase inversion in the presence of azlactone functional particles, which unexpectedly survived the conditions of solvent phase membrane formation.

EP 0 266 580 (Excorim KB) relates to the field of chromatography and immunoadsorption therapy and discloses a support that exhibits a large active surface and low flow resistance. More specifically, the support disclosed therein in comprised of a solid inner core, with only small pores or no pores at all, coated with a thin layer of a gel. The gel is intended for binding of adsorbent groups. The coating is carried out by mixing hydrophilic particles with a gel-forming substance, at a temperature above its gelling temperature, so as to cover each individual particle, whereupon the particles are separated from each other and cooled. The separation may take place by dispersion of the coated particles in a hydrophobic solvent. The preferred material for the particles is a hydrophilic glass, but PVC, polyamides or polycarbonates are also suggested. The coating may e.g. be agarose.

WO 92/13027 relates to a method of forming finely divided polymer particles, including polymer-encapsulated particles useful as liquid toners for electrophoretic imagining. More specifically, the method comprises the steps of forming a solution of a polymer in a selective solvent therefor, including the component to be encapsulated within the polymer, heating the solution, and subsequently cooling the solution to effect precipitation of the dissolved polymer as a particulate polymer, or precipitated as a polymer-encapsulated particulate. Also disclosed is a method of forming fine polymer particles of the core/shell type, similarly forming a solution of a pair of homopolymers in a selective solvent, wherein a first change of condition causes one of the polymers to precipitate as a suspension of fine particles serving as core particles and a second change of condition causes the other polymer to precipitate encapsulating the core particles. The precipitated particles can be washed to remove any residual organic solvent to form a liquid toner for electrophoretic imaging use. Alternatively, the precipitated polymer-encapsulated particles can be dried to form a dry powder. Thus, the products of the disclosed methods are separated particles.

Despite the many suggested methods, there is still a need in this field of improved methods to prepare separation media as well. There is also a continuous need of novel separation media that exhibits different properties from the prior art.

### SUMMARY OF THE PRESENT INVENTION

One object of the invention is to provide a method of preparing a separation medium with hierarchical pore structure. This can according to the present invention be achieved by a method, wherein porous polymer beads are aggregated in a solution of a dissolved natural polymer, which is subsequently gelled into a porous gel to produce aggregates of porous and essentially spherical polymer beads within a gel, as is more specifically defined in the appended claims.

Another object of the invention is to provide a separation medium with improved mass transport properties as compared to the prior art media. This can be achieved by a porous polymeric separation medium wherein the pore structure is hierarchical. More specifically, a separation medium according to the invention is comprised of at least one aggregate, and each aggregate comprises a plurality of porous and essentially spherical polymer beads within a gel.

Another object of the invention is to provide a separation medium, which is useful in chromatography, either in particle form, e.g. in packed or expanded bed adsorption, or in the form of a membrane.

Yet another object of the invention is to provide a separation medium, which exhibits two different kind of ligands.

A further object of the invention is to provide a separation medium, which is especially suitable for use in expanded bed adsorption (EBA). This can be achieved according to the invention by a separation medium, the weight of which is suitable for expanded beds. Further objects and advantages of the present invention will appear from the claims and the detailed description that follows below.

### BRIEF DESCRIPTION OF THE DRAWINGS

FIG. 1 is a schematic representation of how essentially spherical porous polymer beads are contacted with a solution of melted polymer and aggregated by emulsion into a separation medium according to the invention.

FIG. 2 is a photograph of the aggregates obtained by the method according to the invention using SP Sepharose™ HP (Amersham Biosciences, Uppsala, Sweden), as described in detail in Example 1 below.

FIG. 3 is another photograph of the aggregates obtained by the method according to the invention using SP Sepharose™ HP (Amersham Biosciences, Uppsala, Sweden).

FIG. 4 is a photograph of the aggregates obtained by the method according to the invention using Source™ 15 Q (Amersham Biosciences, Uppsala, Sweden), as described in detail in Example 2 below.

FIG. 5 is another photograph of the aggregates obtained by the method according to the invention using Source™ 15 Q (Amersham Biosciences, Uppsala, Sweden), as described in detail in Example 2 below.

### DEFINITIONS

The term “hierarchical” is used herein to describe a porous structure with large pores open to the exterior. On the walls of these large pores, a system of smaller pores opens. Optionally, a further system of even smaller pores may open on the walls of these pores etc.

The term “separation medium” is used herein in a broad sense to include any material that is useful as the stationary phase in a separation method, such as a chromatographic process or a filtration. The medium can be used as such or combined with another material, such as a rigid support in a filtration. Further, a “separation medium” as used herein will include both materials that are directly useful for adsorption or sieving and such materials having additional adsorbing groups, known as ligands, coupled thereon.

### DETAILED DESCRIPTION OF THE INVENTION

A first aspect of the present invention is a method of preparing a separation medium comprised of at least one essentially spherical aggregate, comprising the steps of
(a) providing a slurry of essentially spherical polymer beads in an aqueous solution of a natural polymer by heating to a temperature above the melting point of said natural polymer;
(b) contacting the slurry from step (a) with an organic solvent in the presence of emulsifier to allow aggregation of the beads;
(c) subjecting the resulting mixture to stirring;
(d) cooling the stirred mixture to a temperature below the gel point of the natural polymer to gel the solution surrounding the beads and removing any excess of emulsifier; and, optionally,
(e) sieving the aggregate(s) formed:
   wherein the resulting aggregate(s) each comprise a plurality of porous polymer beads assembled by a porous gel.

The slurry provided in step (a) comprises any suitable kinds of bead in an aqueous solution, preferably water, such as deionised water.

In one embodiment, the beads are natural polymers, such as agarose or dextran. Porous polymer beads of natural polymers are either easily performed by the skilled person in this field according to standard methods, such as inverse suspension gelation (S Hjertén: Biochim Biophys Acta 79(2), 393-398 (1964) or spinning disk technique (see e.g. WO 88/07414 (Prometic Biosciences Inc)).

Alternatively, such natural polymer beads are obtained from commercial sources, which beads are then aggregated in accordance with the present invention. Illustrative tradenames of such useful natural polymer beads are e.g. of the kind known as Sepharose™ or Sephadex™ (Amersham Biosciences AB, Uppsala, Sweden). In a specific embodiment, the present separation medium is prepared from beads comprised of compact agarose. Such compact agarose is prepared by a method disclosed in a pending patent application (GB 0314993.7 in the name of Amersham Biosciences), which is hereby incorporated in this application. In brief, the method comprises to produce a slurry by suspension of agarose beads in; to add one or more metal-salts, such as Na₂SO₄ and/or MgSO₄; to heat the slurry with stirring, preferably to a temperature above about 90° C.; to cool and filter the slurry; and optionally to wash the filtrate, e.g. with distilled or deionized water. In a preferred embodiment, said steps are repeated.

In an alternative embodiment, the beads are comprised of synthetic polymers, such as divinylbenzene or styrene. Synthetic polymer beads are easily produced according to standard methods, see e.g. “Styrene based polymer supports developed by suspension polymerization” (R Arshady: Chimica e L'Industria 70(9), 70-75 (1988)). Alternatively, a commercially available product, such as Source™ (Amersham Biosciences AB, Uppsala, Sweden), is aggregated in accordance with the present invention.

In yet an alternative embodiment, the beads are of inorganic nature, e.g. silica. Such beads and the preparation thereof are also well-known in this field.

Thus, a slurry of essentially spherical polymer beads in an aqueous solution of a natural polymer is provided by heating to a temperature above the melting point of said natural polymer to provide a viscous solution. A minimum amount of water is desired, which in principle should be just sufficient to provide interconnection between the beads. In an advantageous method, the ratio natural polymer:beads in step (a) is 0.1:100, such as 1:100, calculated as the mass ratio (weight/weight).

The natural polymer dissolved in step (a) can be any polymer capable of forming a porous gel, and is usually capable of irreversible gelling on cooling of a melted solution thereof. In one embodiment of the present medium, the natural polymer is selected from the group that consists of agarose, gelatine, agar, cellulose, dextran, chitosan, konjac, carrageenan, gellan, and alginate, or a mixture of two or more thereof. In the most preferred embodiment, the polymer gel is agarose.

The aqueous solution provided in step (a) is usually provided in a conventional reactor, as is well known in the field. The contact according to step (b) is provided simply by mixing the slurry from step (a) with the organic solution, e.g. by adding the slurry to the reactor wherein the organic solution was prepared. The stirring speed is set to provide a desired size of the aggregates. As is well known, in addition to control of the stirring speed, the amount of emulsifier will also influence the size of the aggregates. In one embodiment, the size of the aggregates is controlled to be within a range of about 50-2000 μm, such as about 500-1000 μm.

For some applications, such as chromatography, it is most preferred that the shape of the aggregates is spherical. The skilled person can easily adapt the ratio of aqueous phase:organic phase in the solution of step (b) to provide essentially spherical aggregates. Thus, in one embodiment, said ratio aqueous phase:organic phase is controlled to provide essentially spherical aggregates. In this context, the term “essentially spherical” is understood to mean a bead, wherein the aspect ratio r is close to or equal to 1, such as about 0.8-1.2, and preferably 0.9-1.1.

In one advantageous embodiment of the present method, the cooling is performed by adding the stirred mixture to a cool solution of organic solvent, such as dichloroethane. In this context, “cool” is understood to mean a temperature below the gel point of the natural polymer, such as between 30° C. and 45° C., and preferably between 35° C. and 40° C. In one embodiment, the mixture is subsequently washed in an organic solvent, such as ethanol, to remove any excess of emulsifier.

The sieving of step (e) is a preferred step for most applications and easily performed according to standard procedures and using standard equipment.

In one embodiment, in a step following step (d), the polymers of the gel are chemically crosslinked. Such crosslinkers are commercially available and standard methods for crosslinking natural polymers are well-known to the skilled person in this field. Thus, in an advantageous embodiment of the present method, the natural polymer gel that assembles the beads into aggregates is crosslinked agarose. Agarose and other gelling polymers are readily available from a wide range of suppliers.

Depending on the starting materials used, the present separation medium can be further derivatised with ligands i.e. binding groups suitable for chromatography. Thus, in one embodiment, the gel is derivatised in a step subsequent to step (f) above. In brief, hydroxyl groups present in the agarose may be derivatised e.g. with glycidol. Plural molecules of glycidol may be polymerically attached to the hydroxyl by addition of boron trifluoride etherate to produce a covalent coating comprising polymer chains including plural hydroxyls. Alternatively, hydroxyls may be oxidised to produce plural carboxylic acid groups. In another embodiment, the hydroxyl may be reacted with a compound such as an epihalohydrin, such as epibromohydrin, to produce a terminal halide on the covalent coating, which may be reacted with an amine to produce a quaternary amine. Techniques for derivatisation of natural polymers, such as agarose, are well known in this field, for more details see e.g. WO 98/33572 (Amersham Pharmacia Biotech).

If the beads used in step (a) are of natural polymers, then a corresponding derivatisation may be performed thereof. Alternatively, as mentioned above, the beads used in step (a) may be already derivatised separation matrices available as commercial products or prepared before.

A second aspect of the present invention is a separation medium comprised of one or more essentially spherical aggregates, wherein each aggregate comprises a plurality of porous and essentially spherical polymer beads assembled into aggregates by a porous gel. In an advantageous embodiment, each aggregate is comprised of at least about 10 beads in diameter, and preferably at least about 20, beads, as will be discussed in more detail below. The present separation medium can be used e.g. as the stationary phase in chromatography or as a membrane in filtration processes.

In one embodiment, the ratio gel: beads in each aggregate is about 0.1:100, such as about 1:100, calculated as the mass ratio (weight/weight). In this context, it is understood that the term “gel” refers to the surrounding gelled natural polymer phase. Thus, in the most preferred embodiment, the amount of gel is kept to a minimum, i.e. just sufficient to assemble the beads into aggregates. Thus, in this embodiment, the gel acts as glue or a bonding agent and will in principle coat the beads. In an alternative embodiment, each aggregate is comprised of a larger proportion of gel, and such aggregates consist of beads present in a continuous gel phase. Thus, in this embodiment, the beads are embedded in gel. However, in its broadest embodiment, the present invention encompasses any embodiment in between the two above-mentioned, i.e. with any ratio gel:polymer beads. As the skilled person will realise, in this context, the reference herein to the proportion of gel will correspond to the proportion of the aqueous solution wherein the polymer beads are provided in the slurry of step (a) of its method of preparation.

As mentioned above in relation to the first aspect of the invention, the polymers of the gel comprises a natural polymer selected from the group that consists of agarose, gelatine, agar, cellulose, dextran, chitosan, konjac, carrageenan, gellan, and alginate, or a mixture of two or more thereof. In the most preferred embodiment, the polymer gel is agarose.

In an advantageous embodiment, the polymers of the gel have been chemically crosslinked. Aggregates comprised of chemically crosslinked gel as the matrix that surrounds the polymer beads within the aggregate may provide a more tolerant separation medium than other embodiments, for example as concerns cleaning and/or packing procedures using rougher methods. However, aggregates comprising gel without chemical crosslinks have been shown to resist a conventional sieving process, which is usually relatively rough as well, and even ultrasonic cleaning procedures. Still, a crosslinked gel matrix may be preferred for certain applications, such as when a high flow resistance is desired. The porosity of the gel will depend on the nature of the polymer and the method of preparation. However, in an advantageous embodiment, the pore size and pore distribution within the present gel are similar to the properties of commercially available beads of such natural polymers.

Accordingly, since the beads that constitute the aggregates are porous in themselves, and since the surrounding gel is also porous, the aggregates according to the present invention will present a hierarchical pore structure.

As regards the size of the aggregates, a minimal number of beads will in practise be required to form a spherically shaped aggregate, but this number will e.g. depend on the size of the beads. In one embodiment, the average aggregate in the present medium is comprised of at least about 10 beads in diameter, and preferably at least about 20, such as at least 100 beads in diameter. The desired upper limit of the number of beads in each aggregate will depend on the intended use thereof. Thus, in one embodiment, the average aggregate in the present medium is comprised of up to about 400 beads in diameter, such as up to about 200 beads in diameter. Accordingly, the size of the present aggregates can vary within wide limits, such as from a few μ up to several hundreds or even a thousand μ in particle diameter, e.g. between about 50 and 2000 μm, such as 100-1000 μm. As mentioned above, the number of beads in each aggregate i.e. the size of the aggregate can be controlled by the stirring speed as well as on the amount of emulsifier used in the preparation thereof. In principle, by selection of the appropriate parameters during the preparation, an aggregate of desired size can be prepared.

In an advantageous embodiment of the present medium, the shape of the aggregates is essentially spherical. A spherical shape is advantageous e.g. in chromatographic processes, since it improves the flow properties of an aggregate used as a stationary phase. As the skilled person in this field knows, the particle shape of an emulsified particle will depend on such parameters as the viscosity of the slurry, and in this case the ratio between beads and solution, as will be discussed in more detail below in relation to the third aspect of the invention.

In one embodiment of the present medium, the polymer beads comprise one or more natural polymers selected from the group that consists of agarose, gelatine, agar, cellulose, dextran, chitosan, konjac, carrageenan, gellan, and alginate, or a mixture of two or more thereof. In an advantageous embodiment, the beads are polysaccharides, such as agarose or dextran. In a specific embodiment, the beads comprise an agarose matrix grafted with a layer of dextran. Such beads can be obtained as discussed above in relation to the method.

In an alternative embodiment of the medium, the polymer beads comprise crosslinked synthetic polymers, such as styrene or styrene derivatives, divinylbenzene, acrylamides, acrylate esters, methacrylate esters, vinyl esters, vinyl amides etc. Such beads can be obtained as discussed above in relation to the method.

However, the polymer beads can alternatively be of inorganic nature, e.g. silica.

The aggregates can comprise one of the above-mentioned kind of beads or a mixture of such beads. Further, the beads can be of essentially the same size or of sizes that varies within a certain range. Commercially available beads are generally available either in one defined size or of a size within a certain range. The intended use of the aggregates will decide whether beads of one or more sizes are desired.

As indicated above, commercially available beads are often provided in crosslinked state and sometimes in physically gelled states, depending on the nature of the polymer. Thus, in one embodiment, the polymers of the porous beads have been chemically crosslinked. Likewise, the pore size and porosity of the beads will depend on the kind of bead used in the preparation thereof.

Thus, the aggregates according to the invention will exhibit equivalent binding properties as the beads included therein, since the surfaces of the beads will also be available in a separation medium comprising such beads. Accordingly, a first separation property or function will be provided by the included beads. Illustrative examples of such properties are e.g. ion-exchange ligands, affinity groups, hydrophobically interactive surfaces etc. However, in a specific embodiment, the present separation medium also comprises a second such property or function, which is provided by the agarose matrix, i.e. the interconnecting agarose. Thus, in a specific embodiment, the hydroxyl groups of the agarose matrix have been derivatised into binding groups i.e. ligands. Such derivatisation of agarose is well known to the skilled person in this field and easily performed according to standard methods.

In an advantageous embodiment, the present medium has been prepared by a method as defined above.

As mentioned above, the present medium can e.g. be used in chromatography or in filtration. Thus, the gel and optionally also the beads may have been derivatised as discussed above to provide suitable binding groups. As is easily realised, the nature of the binding groups will decide what kind of chromatography the present separation medium is useful in, e.g. ion exchange chromatography, affinity chromatography, hydrophobic interaction chromatography etc.

Thus, in one embodiment, the medium is comprised of a plurality of the above-defined aggregates as separate and essentially spherical entities and is suitable for use in packed or expanded bed adsorption. Such chromatographic methods are well known to the skilled person in this field.

In an alternative embodiment, the medium is a membrane comprised of a plurality of said aggregates assembled onto a support and suitable for use in filtration. The preparation of a membrane from an adsorbing medium such as the present is well known to the skilled person in this field.

Another aspect of the present invention is the use of porous and essentially spherical polymer beads for the preparation of a separation medium, which medium is comprised of at least one aggregate, each aggregate being comprised of a plurality, such as at least 10 and preferably at least 20, beads assembled by a porous polymer gel. Thus, in one embodiment, the present use is of any bead selected from the group that consists of Sepharose™, Sephadex™ or Source™ (all available from Amersham Biosciences AB, Uppsala, Sweden). Further details regarding this aspect will appear clearly from the detailed description above.

A last aspect of the present invention is a process for separating at least one compound from a liquid comprising the steps of contacting said liquid with a separation medium according to the invention or prepared according the invention to adsorb the compound to said medium. Methods of chromatography are well-known in this field and the skilled person can easily adapt the process in suitable ways. In brief, in a first step, a solution comprising a desired compound is passed over a separation medium according to the invention under conditions allowing adsorption of the compound to ligands i.e. binding groups present on said matrix. Such conditions are controlled e.g. by pH and/or salt concentration i.e. ionic strength in the solution. Care should be taken not to exceed the capacity of the medium, i.e. the flow should be sufficiently slow to allow a satisfactory adsorption. In this step, other components of the solution will pass through in principle unimpeded. Optionally, the medium is then washed, e.g. with an aqueous solution, in order to remove retained and/or loosely bound substances. In a next step, a second solution denoted an eluent is passed over the medium under conditions that provide desorption i.e. release of the desired compound. Such conditions are commonly a decrease of the pH and/or an increase of the salt concentration i.e. ionic strength. As the pH drops, the net charge on the compound will change as it becomes more positive, and hence alter many of the opportunities that it has for electrostatic interactions. Similarly, the increase of the ionic strength by addition of a salt will also alter the affinity between the compound and the ligand. If more than one compounds are present in the liquid, other compounds than the desired one may adsorb to the medium. The desired compound and any further compound(s) will subsequently be available for selective elution since they desorb from the medium at different conditions.

The desired compound may be a any compound, such as a recombinantly produced protein, peptide, nucleic acid, virus etc, or alternatively an undesired contaminant, such as an organic compound, which it is desired to remove from a liquid.

As an illustrative example of separation of a desired target compound, plasmid purification is mentioned. In this case, the relatively large size of the pores of the aggregates of the present separation medium is advantageous, as compared to use of the constituting beads as such as conventional medium.

Another application where the present invention may prove especially advantageous is in expanded bed adsorption chromatography, where a certain minimum density of the particles is desired. Such a density is easily provided by the aggregates according to the invention.

Additional applications of the present aggregates are e.g. as carriers in cell culture, in which case larger beads are advantageous, optionally of a relatively wide spread size distribution, or as carriers in various delivery systems, such as drug delivery.

### DETAILED DESCRIPTION OF THE DRAWINGS

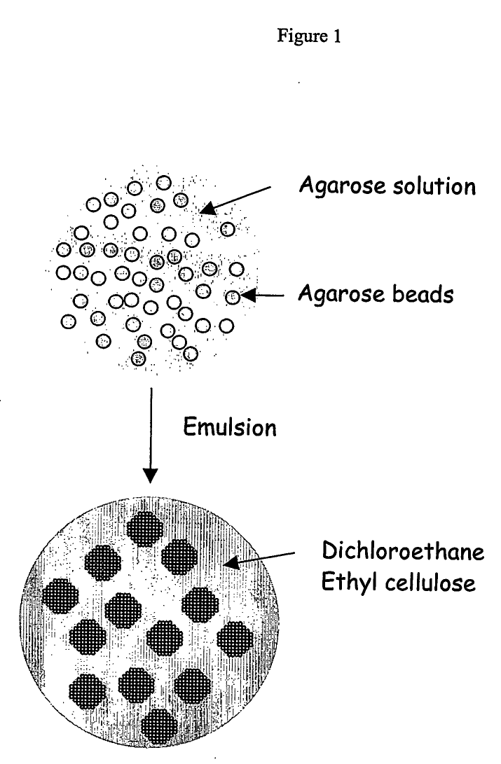

FIG. 1 is a schematic representation of how essentially spherical porous polymer beads are contacted with a solution of melted polymer and aggregated by emulsion into a separation medium according to the invention. The natural polymer is illustrated with agarose, and the beads are in this case also made from agarose. The agarose solution is suspended in a solution of 1,2-dichloroethane/ethyl cellulose, wherein the ethyl cellulose acts as emulsifier.

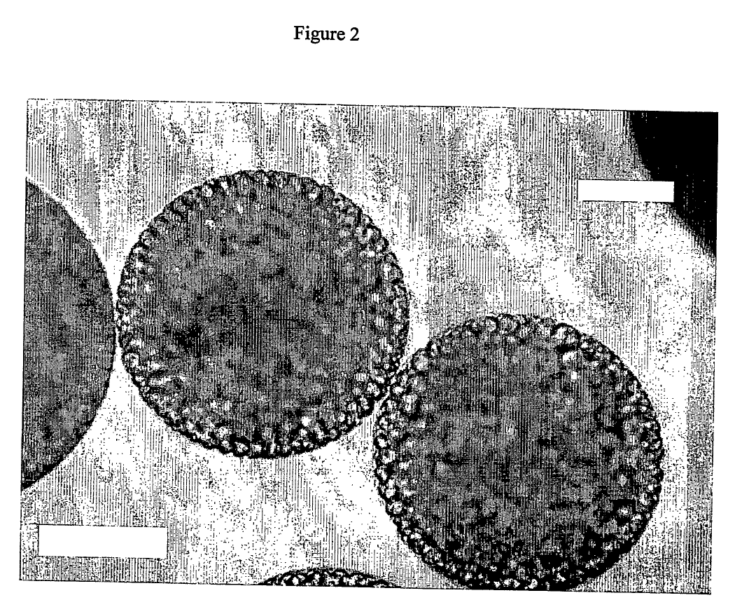

FIG. 2 is a photograph of the aggregates obtained by the method according to the invention using SP Sepharose HP™ (Amersham Biosciences, Uppsala, Sweden). Thus, the aggregates shown are comprised of natural polymer beads assembled by agarose, as explained in Example 1 below. In FIG. 2, 3 cm correspond to 210 μm. The picture shows how a plurality of beads together make up a spherical aggregate.

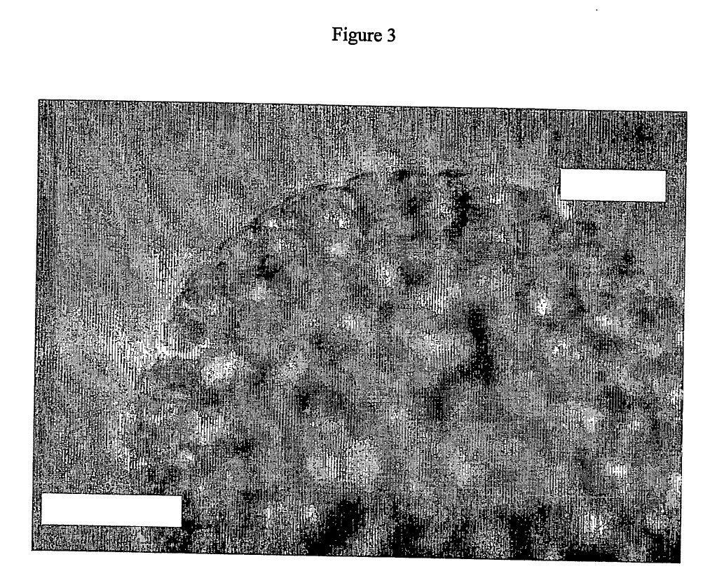

FIG. 3 is a photograph of the aggregates obtained by the method according to the invention using SP Sepharose HP™ (Amersham Biosciences, Uppsala, Sweden). In FIG. 3, 2.7 cm correspond to 64.3 μm. The picture shows how the beads are closely packed in the aggregate, with basically no more gel between them than what is necessary to glue them together and create an aggregate.

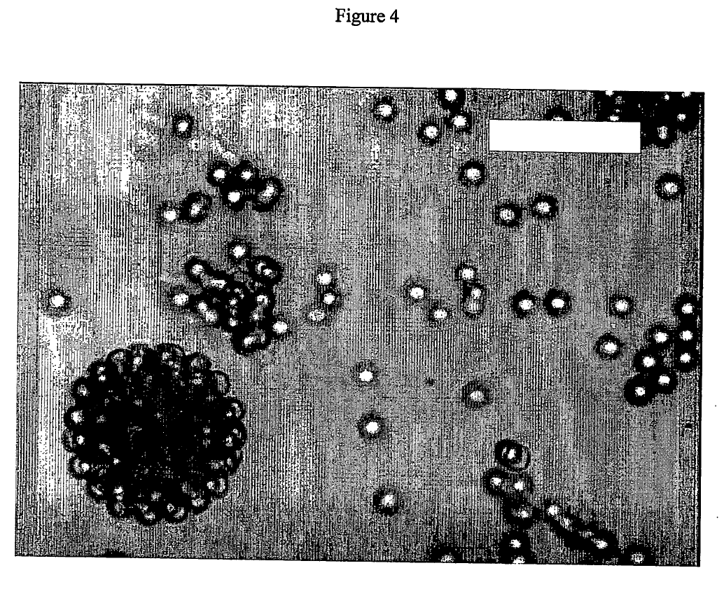

FIG. 4 is a photograph of one of the aggregates obtained by the method according to the invention using Source™ 15 Q (Amersham Biosciences, Uppsala, Sweden). Thus, the aggregate shown is comprised of synthetic polymer beads assembled by agarose, as described in detail in Example 2 below. The picture shows how a plurality of beads together makes up a spherical aggregate.

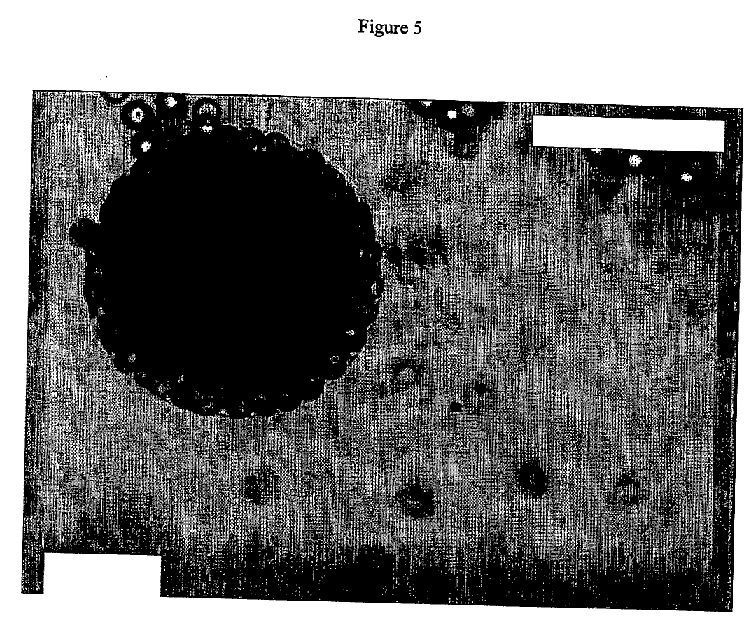

FIG. 5 is another photograph of the aggregate obtained by the method according to the invention using Source™ 15 Q (Amersham Biosciences, Uppsala, Sweden), as described in detail in Example 2 below. In FIG. 5, 2.2 cm correspond to 50 μm.

### EXPERIMENTAL PART

The present examples are provided for illustrative purposes only, and should not be construed as limiting the present invention as defined in the appended claims. All references given below and elsewhere in the present specification are hereby included herein by reference.

### Example 1

### Preparation of Aggregates from Natural Polymer Beads (Sp Sepharose™ HP)

150-200 ml of SP Sepharose™ HP (Amersham Biosciences, Uppsala, Sweden) separation matrix in bead form (bead size 30μ) is washed with distilled water on a glass filter to remove the ethanol present. A 0.2M sodium sulphate solution (1200-1500 ml) is then poured onto the washed beads portionwise and allowed to drain through them. A 250-ml three-necked round-bottom flask equipped with a mechanical stirrer and a thermometer is fitted up in a heating bath containing glycerol. 60 ml distilled water is charged into the flask followed by 1.9 g agarose under stirring. The stirred mixture is then heated to dissolve the agarose (bath temperature 90-95° C.). After the agarose has dissolved, stirring is continued for 30 minutes at the same temperature.

95 g of the aforementioned drained separation matrix is then added to the stirred agarose solution. The temperature of the slurry is adjusted to 80° C.±2° C. and stirred for 30 minutes. The stirring is then stopped and the agarose/bead slurry is then poured into the ethylene dichloride/ethyl cellulose solution (as described below) to form the emulsion. 300 ml ethylene dichloride is charged into a 500-ml straight-sided loose-lidded sleeved reaction flask fitted with a stirrer of turbo type and connected to a circulation bath. The stirring is started and 10 g ethyl cellulose is added portionwise. After 30 minutes, the temperature in the circulation bath is raised to 30° C. Stirring is continued and ethyl cellulose dissolves (1-2 hours). The temperature in the circulation bath is then fixed to 62° C. After 30 minutes at this temperature, the speed of the stirrer is adjusted to 360 rpm and the agarose/gel slurry is poured into the reactor. An emulsion is formed almost immediately. The emulsion is kept stirring for 30 minutes before being transferred for cooling to the reactor containing cold ethylene dichloride (as described below).

1300 ml ethylene dichloride is charged into a 2-litre straight-sided loose-lidded sleeved reaction flask fitted with a stirrer (anchor type) and connected to a circulation bath. The stirring is started and the temperature set at 17° C. When the circulation bath temperature has been at 17° C. for 20 minutes, the aforementioned emulsion mixture is poured into the cooling mixture with moderately vigorous stirring. After 20 minutes, 500 ml ethanol (99.5%) is added and the reaction mixture clarifies. The aggregates formed float to the surface and are removed from the reaction vessel and transferred to a beaker containing 500-600 ml ethanol. The emulsifier, ethyl cellulose, dissolves in ethanol. This washing step is repeated several times (3-4 times) until the ethanol used is free of the emulsifier. The aggregates are then washed with distilled water before being transferred to a suitable bottle in which they are covered with distilled water.

The bead size distribution of the resulting SP Sepharose™ HP aggregates is 200-2000 μm, the size of each initial bead being 30 μm.

Pictures of the formed aggregates are shown in FIGS. 2 and 3.

### Example 2

### Preparation of Aggregates from Synthetic Polymer Beads (Source™ 15 Q)

100-150 ml of Source™ 15 Q (Amersham Biosciences, Uppsala, Sweden) separation matrix in bead form (bead size 15 μm) is washed with distilled water on a glass filter to remove the ethanol present and water is allowed to drain through them.

A 250-ml three-necked round-bottom flask equipped with a mechanical stirrer and a thermometer is fitted up in a heating bath containing glycerol. 60 ml distilled water is charged into the flask followed by 1.5 g agarose under stirring. The stirred mixture is then heated to dissolve the agarose (bath temperature 90-95° C.). After the agarose has dissolved, stirring is continued for 30 minutes at the same temperature.

60 g of the aforementioned drained separation matrix is then added to the stirred agarose solution. The temperature of the slurry is adjusted to 80° C.±2° C. and stirred for 30 minutes. The stirring is stopped, and the agarose/bead slurry is then poured into the ethylene dichloride/ethyl cellulose solution (as described below) to form the emulsion.

300 ml ethylene dichloride is charged into a 500-ml straight-sided loose-lidded sleeved reaction flask fitted with a stirrer of turbo type and connected to a circulation bath. The stirring is started and 10 g ethyl cellulose is added portionwise. After 30 minutes, the temperature in the circulation bath is raised to 30° C. Stirring is continued and ethyl cellulose dissolves (1-2 hours). The temperature in the circulation bath is then fixed to 62° C. After 30 minutes at this temperature, the speed of the stirrer is adjusted to 360 rpm and the agarose/gel slurry is poured into the reactor. An emulsion is formed almost immediately. The emulsion is kept stirring for 30 minutes before being transferred for cooling to the reactor containing cold ethylene dichloride (as described below).

1300 ml ethylene dichloride is charged into a 2-litre straight-sided loose-lidded sleeved reaction flask fitted with a stirrer (anchor type) and connected to a circulation bath. The stirring is started and the temperature set at 17° C. When the circulation bath temperature has been at 17° C. for 20 minutes, the aforementioned emulsion mixture is poured into the cooling mixture with moderately vigorous stirring. After 20 minutes, 500 ml ethanol (99.5%) is added whereupon the reaction mixture clarifies. The aggregates formed float to the surface and are removed from the reaction vessel and transferred to a beaker containing 500-600 ml ethanol. The emulsifier, ethyl cellulose, dissolves in ethanol. This washing step is repeated several times, such as 3-4 times, until the ethanol used is free of the emulsifier. The aggregates are then washed with distilled water before being transferred to a suitable bottle in which they are covered with distilled water.

The bead size distribution of the Source™ 15Q aggregates is 100-1000 μl, the size of each initial bead being 15 μm.

Pictures of the formed aggregates are shown in FIGS. 4 and 5.

1. A method of preparing a separation medium comprised of at least one essentially spherical aggregate, comprising the steps of
(a) providing a slurry of essentially spherical polymer beads in an aqueous solution of a natural polymer by heating to a temperature above the melting point of said natural polymer;
(b) contacting the slurry from step (a) with an organic solvent in the presence of emulsifier to allow aggregation of the beads;
(c) subjecting the resulting mixture to stirring;
(d) cooling the stirred mixture to a temperature below the gel point of the natural polymer to gel the solution surrounding the beads and removing any excess of emulsifier; and, optionally,
(e) sieving the aggregate(s) formed:
wherein the resulting aggregate(s) each comprises a plurality of porous polymer beads assembled by a porous gel.

2. The method of claim 1, wherein the mass ratio of natural polymer:beads in step (a) is about 0.1:100, such as about 1:100.

3. The method of claim 1, wherein the ratio of aqueous phase:organic phase in step (b) is controlled to provide essentially spherical aggregates.

4. The method of claim 1, wherein in a step following step (d), the polymers of the gel are chemically crosslinked.

5. The method of claim 1, further comprising characterizing functional groups of the polymers of the gel to provide a separation medium exhibiting two different ligands.

6. A separation medium comprised of one or more aggregates, wherein each aggregate includes a plurality of porous and essentially spherical polymer beads assembled by a porous gel and includes at least about 10 beads.

7. The medium of claim 6, wherein the mass ratio of the assembling gel:beads in each aggregate is about 0.1:100.

8. The medium of claim 6, wherein the gel comprises a natural polymer selected from the group consisting of agarose, gelatine, agar, cellulose, dextran, chitosan, konjac, carrageenan, gellan, and alginate, or a mixture of two or more thereof.

9. The medium of claim 6, wherein the polymers of the gel have been chemically crosslinked.

10. The medium of claim 6, which exhibits one kind of ligand coupled to the beads within the aggregates and another kind of ligand coupled to the polymers of the gel surrounding said beads.

11. The medium of claim 6, wherein the shape of the aggregates is spherical.

12. The medium of claim 6, wherein the polymer beads are comprised of natural polymers.

13. The medium of claim 6, wherein the polymer beads are comprised of one or more synthetic polymers.

14. The medium of claim 6, wherein the polymers of the beads have been chemically crosslinked.

15. The medium of claim 6, wherein the aggregates are separate and essentially spherical entities, which medium is suitable for use in packed or expanded bed adsorption.

16. The medium of claim 6, comprising a membrane including a plurality of aggregates provided on a support, which medium is suitable for use in filtration.

17-18. (canceled)
